(19) United States
(12) Patent Application Publication
(10) Pub. No.: US 2026/0298404 A1
(43) Pub. Date: Oct. 1, 2026

(54) SYSTEM FOR REMOVABLY FASTENING A BIOMETRIC MODULE TO A MODULAR BIOMETRIC TERMINAL

(71) Applicant: IDEMIA PUBLIC SECURITY FRANCE, Courbevoie (FR)

(72) Inventors: Jean-Michel TEYROL, Courbevoie (FR); Michael BARTHE, Courbevoie (FR); Denis DUMONT, Courbevoie (FR)

(73) Assignee: IDEMIA PUBLIC SECURITY FRANCE, Courbevoie (FR)

(21) Appl. No.: 19/557,327

(22) Filed: Mar. 5, 2026

(30) Foreign Application Priority Data
Mar. 28, 2025 (FR) FR2503192

(51) Int. Cl. F16M 13/02; G06V 40/16

(52) U.S. Cl. CPC F16M 13/02; G06V 40/16

(57) ABSTRACT

A system for removably fastening a biometric module to a modular biometric identification terminal, the system comprises:
A seat formed on a rear face of the casing of the modular terminal, said seat comprises an opening provided with a lateral projecting edge;
A retaining tab mechanically secured to the biometric module, said retaining tab, when it is inserted into the seat of the casing, maintains mechanical surface contact with at least a portion of the inner wall of said seat and surrounds the lateral projecting edge of the opening.

### TECHNICAL FIELD

The present invention relates to a system for removably fastening a biometric module to a modular biometric terminal.

### TECHNICAL BACKGROUND

It is common to use protocols for identifying and/or authenticating individuals that are based on comparison of some of their biometric features in order to authorize them to access one or more restricted access areas. These protocols are generally implemented by access control systems placed at the entrance to these areas. These systems comprise biometric identification terminals connected to physical door devices, the opening or closing of which depends on the success or failure of identification or authentication operations carried out by the biometric identification terminals on individuals presenting themselves.

Biometric identification terminals may be provided with one or more devices for acquiring one or more biometric features depending on the type of identification and/or authentication protocol that they implement. The biometric features are generally chosen from among the dermatoglyphs of one or more fingers, palm dermatoglyphs, one or more irises or a face, or a combination thereof. A biometric identification terminal supporting several identification modes, notably from different biometric features, are generally referred to as “multimodal terminals”.

There are multimodal biometric identification terminals, known as “integrated” terminals. These terminals may comprise one or more devices for acquiring one or more biometric features, but cannot be modified. To add, remove or replace an acquisition device, the entire terminal has to be replaced.

WO 2014/160448 A1 [SOLOINSIGHT INC [US]] Oct. 2, 2014 describes an integrated multimodal terminal comprising an iris recognition identification module and a facial recognition identification module.

DE 202022104750 U1 [PRADOTEC SALES & SERVICES SDN BHD [MY]] Jun. 30, 2022 describes an integrated multimodal terminal comprising a dactylogram recognition identification module, an iris recognition identification module, and a facial recognition identification module.

There are multimodal biometric identification terminals, known as “modular” terminals. These terminals are modifiable and generally allow the addition, removal or replacement of one or more biometric modules comprising one or more devices for acquiring one or more biometric features.

WO 2015/104486 A1 [SYSTEMES ET TECHNOLOGIES IDENTIFICATION STID [FR]] Jul. 16, 2015 describes a modular access control card reader comprising temporary fastening means for a complementary biometric module. The temporary fastening system consists of a first flange projecting from the front panel of the card reader casing and a second flange projecting from the rear panel of the base of said casing, the flanges are arranged to align and form a slot into which the retaining tabs of a complementary biometric module can be inserted. The retaining tabs then come to bear on the first flange projecting from the panel.

### SUMMARY OF THE INVENTION

In order to protect against the risks of piracy, damage and/or intrusion affecting devices for acquiring and processing biometric features of biometric identification terminals, the latter are generally installed in casings that are tamper-proof, or at least difficult to penetrate or dismantle. This precaution prevents sensitive electronic components from being exposed. Communication with the terminal is then ensured by suitable connections.

However, the fastening system described in WO 2015/104486 A1 [SYSTEMES ET TECHNOLOGIES IDENTIFICATION STID [FR]] 16 Jul. 2015 is only suitable for card readers. Since the terminal itself comprises a biometric acquisition device, using the front panel of the terminal as a support for the complementary biometric module during assembly and fastening exposes the inside of the terminal, and thus potentially the sensitive electronic components thereof. There is therefore a need for a fastening system adapted to this type of terminal.

A first aspect of the invention relates to a system for removably fastening a biometric module to a modular biometric identification terminal, the system comprises:
A seat formed on a rear face of the casing of the modular terminal, said seat comprises an opening provided with a lateral projecting edge;
A retaining tab mechanically secured to the biometric module, said retaining tab, when it is inserted into the seat of the casing, maintains mechanical surface contact with at least a portion of the inner wall of said seat and surrounds the lateral projecting edge of the opening.

According to some embodiments, the seat comprises a second opening provided with a lateral projecting edge, and the retaining tab, when it is inserted into the seat, surrounds the lateral projecting edge of the second opening.

According to some embodiments, the retaining tab comprises a first branch which, when it is inserted into the seat, maintains mechanical surface contact between a portion of its outer surface and at least a portion of the inner wall of the seat and surrounds the lateral projecting edge of the first opening, and a second branch which, when inserted into the seat, maintains mechanical surface contact between a portion of its outer surface and at least a portion of the inner wall of the seat and surrounds the lateral projecting edge of the second opening.

According to some embodiments, the retaining tab surrounds the lateral projecting edge of the first opening and/or the lateral projecting edge of the second opening by means of an elbow.

According to some embodiments, the retaining tab is made of an elastic material, preferably of thermoplastic polymer, and the dimensions of the tab, in particular the spacing between the two branches, are larger than the seat of the casing of the terminal, so that, when it is inserted into the seat, it exerts a mechanical compression stress on the inner wall of the seat.

According to some embodiments, the retaining tab is inserted into the seat of the terminal by snap-fitting.

According to some embodiments, the retaining tab, notably one or the other of the two branches or both, comprises a channel for the passage of a connection cable between the modular terminal and the biometric module.

According to certain embodiments, the removable fastening system further comprises a tape, preferably made of plastic or cardboard, encircling and overlapping the junction between the modular terminal and the biometric module.

According to some embodiments, the removable fastening system further comprises a closing plate, preferably made of plastic, said closing plate being adapted to be fastened to the seat of the modular terminal so as to close said seat and to lock the retaining tab of the biometric module in said seat.

According to some embodiments, the removable fastening system further comprises a wall mounting bracket, preferably in the form of a metal plate.

A second aspect of the invention relates to a modular terminal and a seat suitable for a removable fastening system according to any one of the embodiments of the first aspect of the invention.

According to some embodiments, the seat is integrated into the casing of the modular terminal or is a part attached to the rear face of said casing.

According to some embodiments, the modular terminal comprises a facial recognition device.

A third aspect of the invention relates to a biometric module comprising a retaining tab suitable for a removable fastening system according to any one of the embodiments of the first aspect of the invention.

According to some embodiments, the retaining tab may be integrated into the casing of the biometric module, forming a single part with said casing, or be a part attached to the casing.

### BRIEF DESCRIPTION OF THE DRAWINGS

FIG. 1 is a schematic representation of a biometric identification system comprising a modular biometric identification terminal provided with a biometric module.

FIG. 2 is a schematic representation of the rear face of the modular biometric terminal.

FIG. 3 is a schematic representation of detail I in FIG. 2.

FIG. 4 is a schematic representation of the biometric module detached from the modular biometric terminal.

FIG. 5 is a schematic representation of the rear face of the biometric module in FIG. 4.

FIG. 6 is a schematic front view of the fastening system when the biometric module is assembled on the biometric terminal.

FIG. 7 is a schematic exploded perspective view of the fastening system when the biometric module is assembled on the biometric terminal.

### DETAILED DESCRIPTION OF THE EMBODIMENTS

With reference to FIG. 1, a biometric identification system 100 may for example comprise a modular biometric identification terminal 101 provided with a biometric module 102. The modular terminal 101 comprises a casing 103 comprising a front main face 103a and a rear main face 103b. An interactive display screen 104 and a facial recognition identification device 105 in the form of a camera are arranged on the front main face 103a.

The biometric module 102 is fastened under the modular terminal 101. In this example, the biometric module 102 comprises a casing 106 in which a device 107 for acquiring digital dactylograms is arranged. This device 107 is used to carry out the facial recognition identification implemented by the modular terminal 101 with identification by fingerprint recognition. According to other embodiments, the biometric module 102 may comprise a device for acquiring one or more digital or palm dactylograms, and/or an iris acquisition device. If it comprises an iris acquisition device, the biometric module 102 can be placed above the biometric terminal 101.

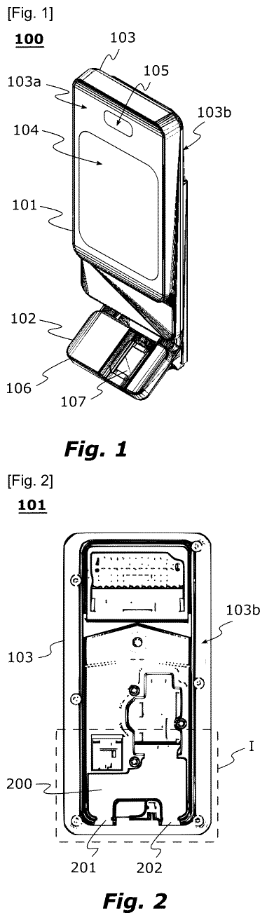

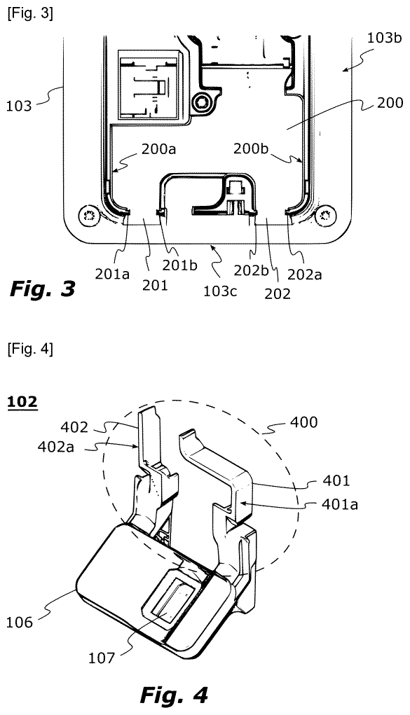

With reference to FIG. 2 & FIG. 3, a seat 200, such as a cavity of substantially rectangular shape, is formed on a rear face 103b of the casing 103 of the modular terminal 101. The seat 200 may be integrated into the casing 103, forming a single part with said casing 103, or may be a part attached to the rear face 103b of the casing 103, such as a part forming a cavity when it is fastened to the rear face 103b of the casing 103, for example using clips or screws.

The seat 200 comprises an inner wall 200a, 200b. It also comprises at least one opening 201 that opens toward the face 103c of the casing 103 adjacent to the biometric module 102. At least one lateral edge 201a of the opening 201 forms a projecting edge. This projecting edge 201a is substantially perpendicular to the plane of the rear main face 103b of the casing 103.

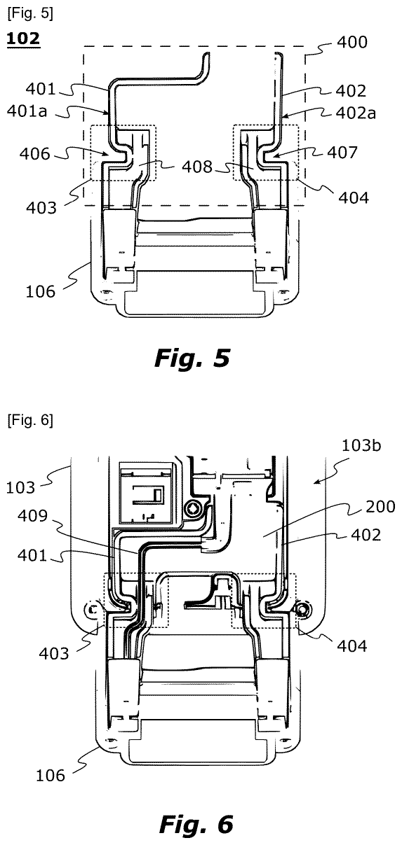

With reference to FIG. 4 & FIG. 5, the biometric module 102 comprises a retaining tab 400, mechanically secured to said biometric module 102. In the example, the retaining tab 400 is a shaped member integrated into the casing 106 of the biometric module 102. The shaped member is preferably made of thermoplastic polymer. In the embodiment illustrated in the figures, the retaining tab 400 is formed by two branches 401, 402 which are aligned with the right and left ends of the casing 106 of the biometric module 102. Each of the two branches 401, 402 comprises an outer lateral surface 401a, 402a.

The retaining tab 400 may be integrated into the casing 106 of the biometric module 102, forming a single part with said casing 106, or may be a part attached to the casing 106, such as a tab 400 fastened to the upper portion of the casing 106, for example using clips or screws.

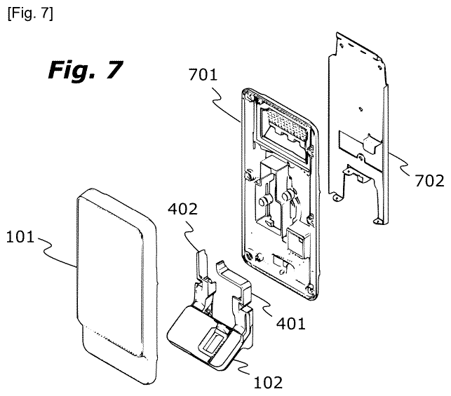

With reference to FIG. 6 & FIG. 7, according to the first aspect of the invention, the seat 200 formed on a rear face 103a of the modular terminal 101 and the retaining tab 400, mechanically secured to the biometric module 102, form a removable fastening system. The dimensions of the retaining tab 400 are adapted to the size of the seat 200 formed on a rear face 103a of the modular terminal 101 to enable it to be inserted into said seat 200. Once the retaining tab 400 has been inserted into the seat 200 of the casing 103 of the modular terminal 101, it maintains mechanical surface contact with at least a portion of the inner wall 200a, 200b of the seat 200 and surrounds the lateral projecting edge 201a of the opening 201.

According to preferred embodiments, illustrated in FIG. 2 & FIG. 3, the seat 200 comprises two openings 201, 202. These openings 201, 202 are formed on either side of the casing 103, close to its lateral ends (right and left). The second opening 202 also opens toward the face 103c of the casing 103 adjacent to the biometric module 102. At least one lateral edge 202a of the second opening 202 forms a projecting edge.

With reference to FIG. 6 & FIG. 7, the retaining tab 400 of the biometric module 102, when it is inserted into the seat 200, also surrounds the lateral projecting edge 202a of the second opening 202. Preferably, the first branch 401 of the tab 400, when it is inserted into the seat 200, maintains mechanical surface contact between a portion of its outer surface 401a and at least a portion of the inner wall 200a of the seat 200 and surrounds the lateral projecting edge 201a of the first opening 201. The second branch 402 of the retaining tab 400, when it is inserted into the seat 200, maintains mechanical surface contact between a portion of its outer surface 402a and at least a portion of the inner wall 200b of the seat 200 and surrounds the lateral projecting edge 202a of the second opening 202.

To allow them to pass through the openings 201, 202, each of the two branches 401, 402 generally comprises a portion 403, 404 having geometrical dimensions in cross section, notably in width and depth, that are adapted to the dimensions of the internal sections of the two openings 201, 202 of the seat 200.

In general, there is extensive mechanical surface contact between the outer surfaces 401a, 402a of the branches 401, 402 of the retaining tab 400 and the inner walls 200a,200b of the seat 200, which gets firmer with more extensive contact between said outer surfaces 401a, 402a and said inner walls 200a, 200b. Advantageously, the size of the branches 401, 402 of the tab 400 is adapted so that the outer surfaces 401a,402a are in contact with at least two thirds or even three quarters of the surface of the inner walls 200a, 200b.

According to preferred embodiments, with reference to FIG. 4, FIG. 5 & FIG. 6, the retaining tab 400 surrounds the lateral projecting edge 201a of the first opening 201 and/or the lateral projecting edge 202a of the second opening 202 by means of an elbow 405, 406. For example, the elbow may be in the form of a “U”, the opening of which is inclined to the vertical. When the retaining tab 400 is inserted into the seat, the portions 403, 404 of the two branches 401, 402 are inserted into the openings 201, 202 and the elbows 405, 406 respectively surround the lateral projecting edges 201a, 202a of the two openings 201, 202.

According to one embodiment (not illustrated), the seat 200 may comprise a single opening 201, for example situated substantially at the center of the seat 200. However, the mechanical support provided in this embodiment is less robust than the embodiment in which the seat 200 comprises two openings 201, 202. If the seat 200 of the casing 103 of the modular terminal 101 comprises a single opening 201, notably situated substantially at the center of the seat 200, the retaining tab 400 may comprise a shaped member formed of two branches having a common portion located at the center of the casing 106 of the biometric module 102. This common portion is then inserted into the single opening 201 of the seat 200 and the two branches 401, 402 then extend along the inner walls 200a,200b of the seat 200. The geometrical dimensions, notably in width and depth, of the section of said common portion are therefore adapted to the dimensions of the single opening 201 of the seat 200. The common portion may comprise the two elbows 403, 404, each elbow being situated on either side of the cross section of the common portion. Each elbow makes it possible respectively to surround the lateral projecting edges 201a, 201b on either side of the opening 201.

According to certain preferred embodiments, the retaining tab 400 is made of an elastic material, preferably of thermoplastic polymer. The dimensions of the tab 400, in particular the spacing between the two branches 401, 402, are larger than the seat 200 of the casing 103 of the terminal 101, so that, when it is inserted into the seat 200, it exerts a mechanical compression stress on the inner wall 200a, 200b of the seat 200. This mechanical compression stress strengthens the hold of the biometric module 102 on the terminal 101.

The retaining tab 400 of the biometric module 102 is inserted into the seat 200 of the terminal 101 in any suitable manner. Preferably, the retaining tab 400 is inserted into the seat 200 of the terminal 101 by snap-fitting. To this end, with reference to FIG. 7, the seat 200, including the two openings 201, 202, may comprise a face open toward the outside of the rear main face 103b of the casing 103 of the modular terminal 101. The retaining tab 400 can then be presented parallel to this open face in order to be inserted therein by snap-fitting it in a direction perpendicular to said open face.

With reference to FIG. 4, FIG. 5 & FIG. 6, the retaining tab 400, notably one or the other of the two branches 401, 402 or both, comprises a channel 408 for the passage of a connection cable 409 between the modular terminal 101 and the biometric module 102. The channel may be formed in the portion of the branches 401, 402 which pass through the openings 201, 202.

According to certain embodiments, the fastening system further comprises a tape (not shown), preferably made of plastic or cardboard, encircling and overlapping the join between the modular terminal 101 and the biometric module 102. The function of this tape is to temporarily hold the assembly of the modular terminal 101 and the biometric module 102 in order to prevent the untimely disconnection of the biometric module 102 when they are being handled by an operator, for example during installation and/or wiring thereof. The tape is intended to be removed just before the installation and final fastening of the assembly of the modular terminal 101 and the biometric module 102.

According to certain embodiments, with reference to FIG. 7, the fastening system further comprises a closing plate 701, preferably made of plastic, said closing plate 701 being adapted to be fastened to the seat 200 of the modular terminal 101 so as to close said seat 200 and to lock the retaining tab 400 of the biometric module 102 in said seat 200. Any suitable type of fastening can be used for the closing plate 701 on the rear face 103a of the casing 103 of the modular terminal 101. Notably, it can be carried out using screws.

In some embodiments, the fastening system further comprises a wall mounting bracket 702, for example in the form of a metal plate, to arrange the assembly of the modular terminal 101 and the biometric module 102 on a wall. The wall mounting bracket 702 can for example be fastened to the closing plate 701 using any suitable means (screws, clips, etc.). The addition of a wall mounting bracket 702 in the form of a metal plate provides rigidity when the assembly of the modular terminal 101 and the biometric module 102 is fastened to a wall.

### References

WO 2014/160448 A1 [SOLOINSIGHT INC [US]] Oct. 2, 2014.
DE 202022104750 U1 [PRADOTEC SALES & SERVICES SDN BHD [MY]] 06.30.2022.
WO 2015/104486 A1 [SYSTEMES ET TECHNOLOGIES IDENTIFICATION STID [FR]] Jul. 16, 2015.

1. A system for removably fastening a biometric module to a modular biometric identification terminal the system comprising:
a seat formed on a rear face of the casing of the modular terminal said seat comprises an opening provided with a lateral projecting edge;
a retaining tab mechanically secured to the biometric module said retaining tab, when inserted into the seat of the casing, maintains mechanical surface contact with at least a portion of the inner wall of said seat and surrounds the lateral projecting edge of the opening.

2. The removable fastening system as claimed in claim 1, wherein the seat comprises a second opening provided with a lateral projecting edge, and the retaining tab, when inserted into the seat, surrounds the lateral projecting edge of the second opening.

3. The removable fastening system as claimed in claim 2, wherein the retaining tab comprises a first branch which, when inserted into the seat, maintains mechanical surface contact between a portion of its outer surface and at least a portion of the inner wall of the seat and surrounds the lateral projecting edge of the first opening and a second branch which, when inserted into the seat, maintains mechanical surface contact between a portion of its outer surface and at least a portion of the inner wall of the seat and surrounds the lateral projecting edge of the second opening.

4. The removable fastening system as claimed in claim 1, wherein the retaining tab surrounds the lateral projecting edge of the first opening and/or the lateral projecting edge of the second opening by means of an elbow.

5. The removable fastening system as claimed in claim 1, wherein the retaining tab is made of an elastic material, preferably of thermoplastic polymer, and the dimensions of the retaining tab, in particular the spacing between the two branches, are larger than the seat of the casing of the terminal so that, when the retaining tab is inserted into the seat, the retaining tab exerts a mechanical compression stress on the inner wall of the seat.

6. The removable fastening system as claimed in claim 1, wherein the retaining tab is inserted into the seat of the terminal by snap-fitting.

7. The removable fastening system as claimed in claim 1, wherein the retaining tab, one or the other of the two branches or both, comprises a channel for the passage of a connection cable between the modular terminal and the biometric module.

8. The removable fastening system as claimed in claim 1, wherein further comprising a tape, preferably made of plastic or cardboard, encircling and overlapping the join between the modular terminal and the biometric module.

9. The removable fastening system as claimed in claim 1, wherein further comprising a closing plate, preferably made of plastic, said closing plate being adapted to be fastened to the seat of the modular terminal so as to close said seat and to lock the retaining tab of the biometric module in said seat.

10. The removable fastening system as claimed in claim 1, wherein further comprising a wall mounting bracket, in the form of a metal plate.

11. A modular terminal comprising a seat suitable for a removable fastening system as claimed in claim 1.

12. The modular terminal as claimed in claim 11, wherein the seat is integrated into the casing of the modular terminal or is a part attached to the rear face of said casing.

13. The modular terminal as claimed in claim 11, further comprising a facial recognition device.

14. A biometric module comprising a retaining tab suitable for a removable fastening system as claimed in claim 1.

15. The biometric module as claimed in claim 14, wherein the retaining tab is configured to be integrated into the casing of the biometric module, forming a single part with said casing, or be a part attached to the casing.

16. The removable fastening system as claimed in claim 2, wherein the retaining tab surrounds the lateral projecting edge of the first opening and/or the lateral projecting edge of the second opening by means of an elbow.

17. The removable fastening system as claimed in claim 3, wherein the retaining tab surrounds the lateral projecting edge of the first opening and/or the lateral projecting edge of the second opening by means of an elbow.

18. The removable fastening system as claimed in claim 2, wherein the retaining tab is made of an elastic material, preferably of thermoplastic polymer, and the dimensions of the retaining tab, in particular the spacing between the two branches, are larger than the seat of the casing of the terminal, so that, when the retaining tab is inserted into the seat, the retaining tab exerts a mechanical compression stress on the inner wall of the seat.

19. The removable fastening system as claimed in claim 3, wherein the retaining tab is made of an elastic material, preferably of thermoplastic polymer, and the dimensions of the retaining tab, in particular the spacing between the two branches, are larger than the seat of the casing of the terminal, so that, when the retaining tab is inserted into the seat, the retaining tab exerts a mechanical compression stress on the inner wall of the seat.

20. The removable fastening system as claimed in claim 4, wherein the retaining tab is made of an elastic material, preferably of thermoplastic polymer, and the dimensions of the retaining tab, in particular the spacing between the two branches, are larger than the seat of the casing of the terminal, so that, when the retaining tab is inserted into the seat, the retaining tab exerts a mechanical compression stress on the inner wall of the seat.
